(19) United States
(12) Patent Application Publication
(10) Pub. No.: US 2012/0045082 A1
(43) Pub. Date: Feb. 23, 2012

(54) HEADSET WITH ELECTROSTATIC DISCHARGE REDUCTION

(76) Inventors: James Wahl, Pittsburgh, PA (US); Gordon Slippy, Murrysville, PA (US); Paul Reynolds, Harmony, PA (US)

(21) Appl. No.: 12/860,414

(22) Filed: Aug. 20, 2010

(51) Int. Cl. H04R 1/10

(52) U.S. Cl. 381/375; 381/384

(57) ABSTRACT

Embodiments of the invention provide for a headset and system including a portable device, wherein the headset includes an electrically conductive band configured to engage a portion of a head of a user and coupling together a headpiece and an earpiece assembly. The headpiece includes an electrically conductive portion that is configured to engage and electrically couple to the user's head. The headpiece is electrically coupled with the conductive band. The earpiece assembly is coupled with the conductive band to engage an ear of a user and has a ground conductor that is electrically coupled between the conductive band and a portable device for coupling the portable device to the head of a user for reducing electrostatic discharge at the head of the user of the portable device.

### FIELD OF THE INVENTION

Embodiments of the invention relate generally to headsets and particularly headsets used with mobile or portable computing devices.

### BACKGROUND

Wearable, mobile and/or portable computing devices, or terminals, are used for a wide variety of tasks. Such devices allow workers using them to maintain mobility, while providing the worker with desirable computing and data-processing functions. Furthermore, such devices may provide a communication link to a more powerful and centralized computer system, which further handles the organization of the tasks being performed. An overall integrated system may involve a combination of a central computer system for tracking and management of the tasks, a plurality of mobile devices and associated peripherals, as well as the people (“users”) who use the devices and interface with the devices and/or the computer system.

To provide an interface between the central computer system and the workers, wearable devices are oftentimes voice-enabled; i.e., are operated using human speech inputs and outputs. As such, the central computer and devices incorporate speech recognition technology and text-to-speech technology. To communicate in a voice-enabled system, for example, headsets are utilized by the user to interface with the portable computing devices. The speech input is provided to the computing devices through a microphone while speech output is provided to the user through a speaker. Thus, users are able to receive voice instructions, ask questions, report the progress of their tasks, collect data, and report working conditions, for example.

One drawback with conventional headsets is that users can build up a static charge. When a user puts on a headset, this static charge is often discharged by the user through the circuitry of the headset, such as the microphone or the speaker. Therefore, the static charge is directed to the user's head. Thus, the user perceives being shocked on the head, such as at the mouth or ear, both of which are sensitive areas of the user's body. This can cause users to dislike such headsets and eschew them for communication, which results in a lower quality of speech input, missed speech output, and a general decrease in efficiency. These electrostatic discharges can further harm circuitry of the headsets, rendering them inoperable. Thus, it is desirable to provide a headset to overcome those issues.

Attempts in the past to protect a person from the static discharge or electro-static discharge have often been directed to complicated systems that a person has to wear or engage with while working. Generally, such systems are often directed to stationary positioning of a person, such as at a desk or workstation. As such, existing systems would interfere with the movements of a person and tasks that they may perform while mobile, such as within a voice-enabled work system where a worker or user travels between different locations. Furthermore, existing attempts to insulate certain components of an electrical system are not desirable, because they increase the size and the weight of the various components. As may be appreciated, it is desirable to keep a headset that is worn by a user as lightweight as possible so that it is not cumbersome, and heavy on the head of a user. Such headsets, as used in voice-enabled systems, for example, are often worn for long periods of time. Therefore, weight and comfort is of paramount concern.

Accordingly, it would be desirable to address the problems and shortcomings within the prior art and to provide active protection for the person wearing the headset, particularly a person wearing a headset for an extended period of time.

### SUMMARY

Embodiments of the invention provide for a headset and system that is designed to provide a dedicated electrical path to a portable device such that the perception of static discharge from the user is substantially reduced or eliminated. Specifically, the headset includes an electrically conductive band and a headpiece that includes an electrically conductive portion that is configured to engage and electrically couple to the user's head. The headpiece is also electrically coupled with the conductive band. The headset further includes an earpiece assembly that is coupled with the conductive band to engage an ear of a user. The earpiece assembly has a ground conductor that is electrically coupled between the conductive band and a portable device for coupling the portable device to the head of a user. The invention reduces or eliminates the electrostatic discharge at the head of the user of the portable device.

These and other advantages will be apparent in light of the following figures and detailed description.

### BRIEF DESCRIPTION OF THE DRAWINGS

The accompanying drawings, which are incorporated in and constitute a part of this specification, illustrate embodiments of the invention and, together with a general description of the invention given above and the detailed description of the embodiments given below, serve to explain the principles of the invention.

FIG. 1 is an illustration of a portable device and a headset, both as worn by a user, consistent with embodiments of the invention;

FIG. 2 is an illustration of the headset of FIG. 1 that further illustrates a temple headpiece and an earpiece assembly thereof;

FIG. 3 is an illustration showing details of the temple headpiece of FIG. 2;

FIG. 4A is cross-sectional view of a portion of one embodiment of the temple headpiece of FIG. 3 taken along the line 4A-4A illustrating the electrical connection of the temple headpiece to a band of the headset;

FIG. 4B is a cross-sectional view of a portion of an alternative embodiment of the temple headpiece of FIG. 3, similar to FIG. 4A, illustrating the electrical connection of the temple headpiece to a band of the headset;

FIG. 5 is an illustration of the earpiece assembly of FIG. 2 with its outer housing removed showing the internal components of that earpiece assembly; and

FIG. 6 is a cross-sectional view of a portion of the earpiece assembly of FIG. 5 along the line 6-6 illustrating the electrical connection of the band to a ground connection of the device.

It should be understood that the appended drawings are not necessarily to scale, presenting a somewhat simplified representation of various features illustrative of the embodiments of the invention. The specific design features as disclosed herein, including, for example, specific dimensions, orientations, locations, values, and shapes of various illustrated components will be determined in part by the particular intended application and use environment. Certain features of the embodiments of the invention may have been enlarged, distorted or otherwise rendered differently relative to others to facilitate visualization and clear understanding.

### DETAILED DESCRIPTION

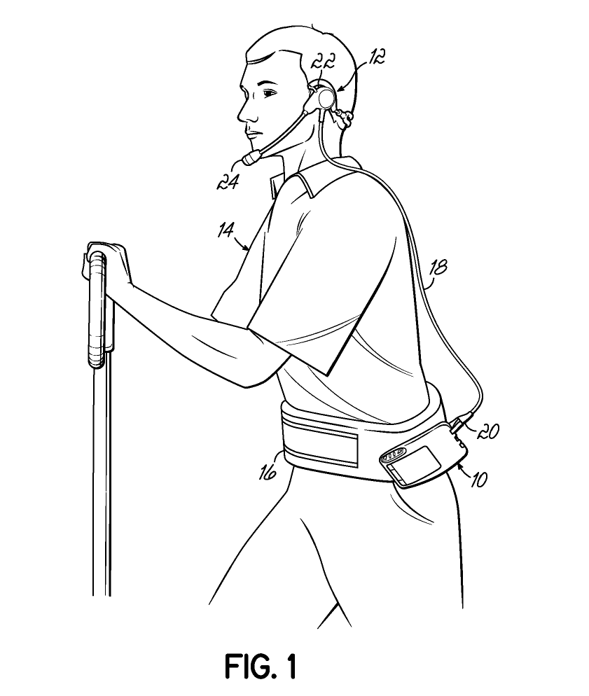

Turning to the drawings, wherein like numbers denote like parts throughout the several views, FIG. 1 is an illustration of a portable and/or wearable computer or device 10 (e.g., “portable device” 10 or, more simply, “device” 10) and a peripheral device or headset 12 (hereinafter, “headset” 12) consistent with embodiments of the invention. In some embodiments, the device 10 is a wearable device, which may be worn by a user 14, such as on a belt 16 as shown. In alternative embodiments, the device 10 is carried or otherwise transported, such as on a lift truck.

In some embodiments, a suitable device 10 may be TALKMAN® or ACCUNURSE® wearable computers or computing devices distributed through Vocollect, Inc., of Pittsburgh, Pa. The device 10 may be used in a voice-enabled system, which uses speech recognition technology for the execution of work tasks, documentation and/or communication. The headset 12 provides hands-free voice communication between the user 14 and the device 10. For example, in one embodiment, the device 10 has a text-to-speech functionality and converts program code instructions to speech dialog (e.g., audio output) to be provided to the user 14 through the headset 12. The user 14 then replies, via speech input, which is converted to a useable digital format (e.g., machine readable input) using a speech recognition functionality to be further processed.

The headset 12 is coupled to the device 10 through a cord or cable 18 and a suitable connector 20. The headset 12 includes a speaker 22 that plays speech output (e.g., such as to instruct the user 14 to perform an action), and a microphone 24 that captures speech input from the user 14 (e.g., such as for conversion to machine readable input by the device 10). The user 14 thus interfaces with the device 10 hands-free through the headset 12.

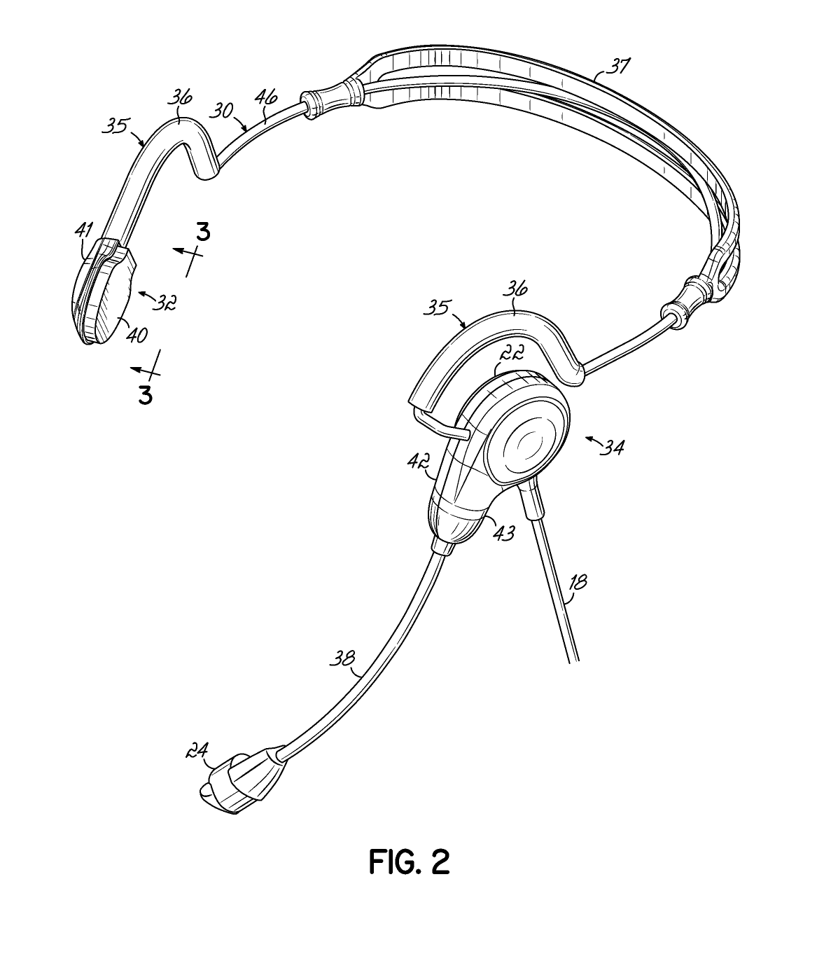

FIG. 2 is a perspective illustration of the headset 12 illustrating that the headset 12 includes a support band 30, a headpiece 32, and an earpiece assembly 34. The support band 30 is configured to engage a portion of a head of a user, such as to wrap around or surround at least a portion of the head of the user 14. The headpiece 32 and earpiece assembly 34 are configured to engage a user's head on opposite sides of the headset. Therefore, in one embodiment, the headpiece 32 and earpiece assembly 34 are coupled to the support band 30 on opposite sides thereof. As such, the support band 30 is shaped to generally correspond to the circumference of the head of the user 14 and configured to be supported by the ears of the user 14.

To that end, the support band 30 thus includes two curved sections as at 35 that may at least partially conform to extend over to the top of the ears of the user 14 for support thereby. When the band 30 is positioned on the head with the curved sections 35 over both ears, the headpiece 32 lies generally against the temple of the user, while earpiece assembly 34 is preferably over one of the user's ears. Each curved section 35 of the support band 30 may be covered by a foam or rubber sheath 36 for greater user comfort. The headset 12 also includes an adjustable headpiece strap 37 that can also be used to hold the headset 12 to the head of the user 14. The strap 37 may be formed of a suitable stretchable material, such as a foam or rubber, for comfort and also to grip a user's head. In this manner, the support band 30, temple headpiece 32, earpiece assembly 34, and/or headpiece strap 37 are configured to support the speaker 22, located in the earpiece assembly 34, at about the location of an ear of the user 14 and the microphone 24, located at the end of a microphone boom 38, at about the location of the mouth of the user 14. Boom 38 may be flexible for positioning of the microphone 24 with respect to the user's mouth.

In one embodiment of the invention, the headpiece includes an electrically conductive portion that is configured to engage a user's head. Specifically, an exposed skin area of the user's head, such as the temple region, is contacted by the headpiece. The temple headpiece 32 includes a pad 40 and a temple headpiece housing 41, while the earpiece assembly 34 includes an inner housing 42 and an outer housing 43 that come together in a generally clam-shell arrangement. The pad 40 is made of a conductive material, such as an electrically conductive foam. The earpiece assembly 34 accepts and attaches to the cord 18 from the device 10 to electrically connect the speaker 22 and the microphone 24 to the device 10, as well as to electrically connect the user 14 to the ground potential of the device 10 as will be discussed below.

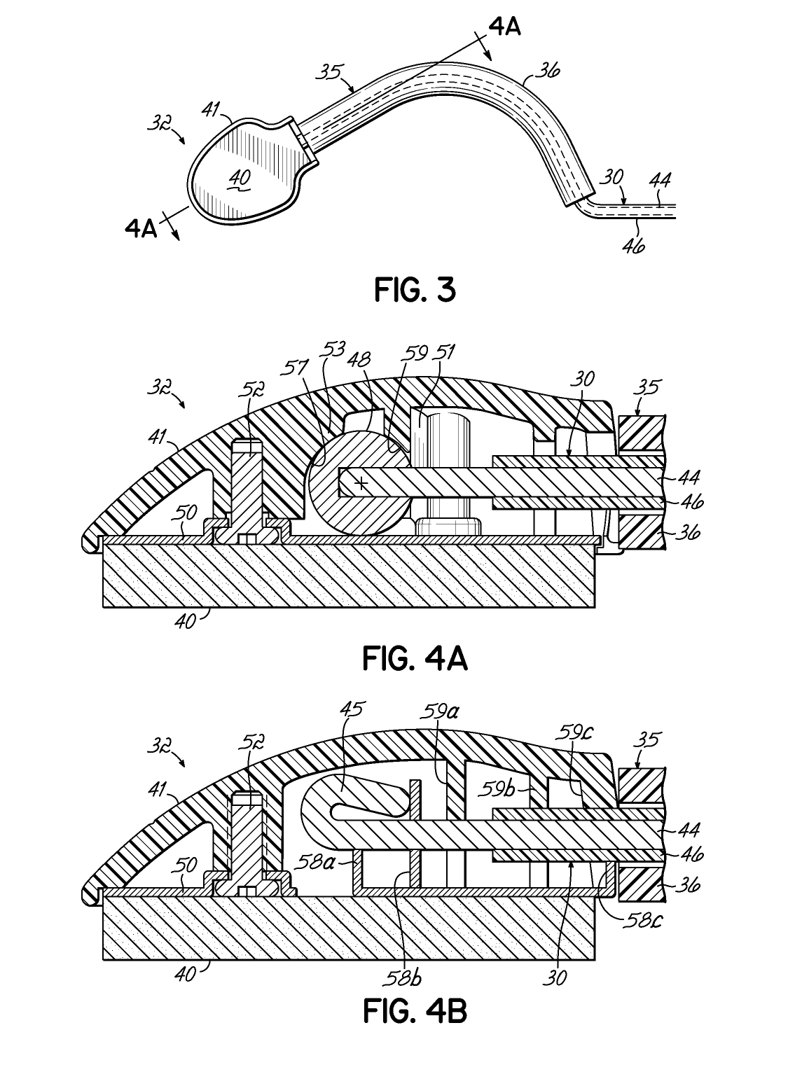

As illustrated in FIGS. 3, 4A-4B, and 5-6, the support band 30 includes an electrically conductive support member 44 (e.g., an electrically conductive band) that is configured to surround a portion of a user's head. The support member 44 is manufactured from a conductive material, such as a suitable metal. In one specific embodiment, the headband is a stainless steel rod that is shaped to generally correspond to the circumference of the head of the user 14. The support member might be covered at least partially by a sheath 46. The sheath 46 may be formed of a suitable rubber, plastic or foam material that is not electrically conductive and so is configured to electrically isolate a portion of the support member 44 that wraps around the head of the user 14.

The support member 44 is configured to be in electrical communication or electrically coupled with the conductive pad 40 and thus, when the headset 12 is worn, with the head of the user 14 through headpiece 32. In one embodiment, and as illustrated in FIG. 4A, the support member 44 extends into the temple headpiece 32 and is connected to, and electrically coupled with, an electrically conductive element, such as a metal ball 48. The ball 48 may be manufactured from metal, and in specific embodiments may be stainless steel. As such, the end of the support member 44 may be welded, soldered, or otherwise threaded onto and/or into the ball 48.

The ball 48 and member 44 are in electrical communication with at least one conductive plate 50. The plate 50 may be formed of metal and serves as a backing plate to conductive pad 40 and is electrically coupled with the pad to provide a good electrical connection between the plate 50 and the pad 40. The pad might be electrically coupled to the plate in a number of ways. The metal plate 50 may be rectangular or have a shape generally corresponding to that of the conductive pad 40. In one embodiment, at least a portion of the metal plate 50 may be attached to the foam pad 40 through an electrically conductive adhesive. The electrical connection between the ball 48 and the metal plate 50 is maintained by the compressive force that the support member 44 exerts on the metal plate 50 when the headset 12 is worn on the head of the user 14. The metal plate 50, and thus the foam pad 40, is held to the temple headpiece housing 41 by at least one headpiece attachment structure 52. As illustrated in FIG. 4A and FIG. 4B, a first portion of a headpiece attachment structure 52 is coupled or attached to the temple headpiece housing 41, while a second portion of the headpiece attachment structure 52 is coupled or attached to the metal plate 50 and the foam pad 40. In specific embodiments, the headpiece attachment structure 52 may be a screw or other fastener that interacts with a threaded portion of the headpiece housing 41.

In accordance with one aspect of the invention, the headpiece 32 is moveable in various directions to provide good electrical contact with the head of a user when the headset is worn. The ball 48 moving in the headpiece 32 provides a universal joint for the pad that allows universal movement of the temple headpiece 32 in various directions to establish comfort and good electrical and physical contact with the head of the user 14. The ball 48 is held between the temple headpiece 32 and the metal plate 50 by engagement of the ball 48 with portions or walls of the housing 41, such as walls 51 and 53. The walls form curved surfaces 59, 57 on the inside of the housing that engage and capture the ball and provide for universal movement of headpiece 32 as the ball moves or rolls against surfaces 57, 59. Other housing walls, not shown by the cross-sectional view of the housing in the Figures, will also engage and capture the ball. This embodiment allows the temple headpiece 32 to rotate and/or move in many directions such that the user 14 is provided with improved comfort and/or improved electrical contact with the headpiece 32.

In an alternative embodiment, and as illustrated in FIG. 4B, the temple headpiece 32 may not include a universal joint or a ball 48. Rather, the foam pad 40 may be electrically coupled with the support member 44 through metal plate 50. The metal plate is configured to be in electrical communication with the support member 44 through at least one projection that extends from plate 50. As illustrated in FIG. 4B, multiple projections 58a-b-c are configured to contact the support member 44. The projections 58a, 58b provide metal-to-metal contact with member 44 to provide electrical coupling between member 44 and plate 50, and pad 40. The support band 30 is inserted through an aperture of the temple headpiece 32 and also held in place by multiple projections or walls 59a-b-c from the temple headpiece housing 41. An unsheathed portion of the support member 44 is in contact with projection 58a and is inserted through an aperture of the projection 58b. As such, the support member 44 is supported by, and electrically coupled with, the first projection 58a and the second projection 58b. Each of the projections 58a-c are manufactured from the electrically conductive material of plate 50, such as stainless steel, such that the support member 44 is electrically coupled with plate 50 and thus the foam pad 40.

In the embodiment illustrated in FIG. 4B, at least a portion of the support member 44 in the temple headpiece 32, and particularly an end of the support member 44 in the headpiece 32, is curved or formed to hold the plate 50 in contact with member 44. For example, end 45 might be bent or shaped as shown in FIG. 4B. The support member 44 is thus prevented from being pulled out of the aperture in the second projection 58b and the temple headpiece 32. At least a portion of the metal plate 50 may be attached to the foam pad 40 through a conductive adhesive. In any event, the plate 50 is electrically coupled with the foam pad 40. The temple headpiece 32 illustrated in FIG. 4B allows rotation along the primary axis defined by a length of the support member 44 that extends into the temple headpiece 32. This provides for some adjustment in headpiece 32 so as to maintain good physical and electrical contact with the user's head while still being comfortable to a user.

Thus, an electrical path is provided from the foam pad 40 to the support member 44 in the temple headpiece 32. The support member 44, in turn, provides an electrical path to the earpiece assembly 34, and specifically an electrical path from the foam pad 40 to the earpiece assembly 34 so as to provide a conductive path to a ground reference, as explained below.

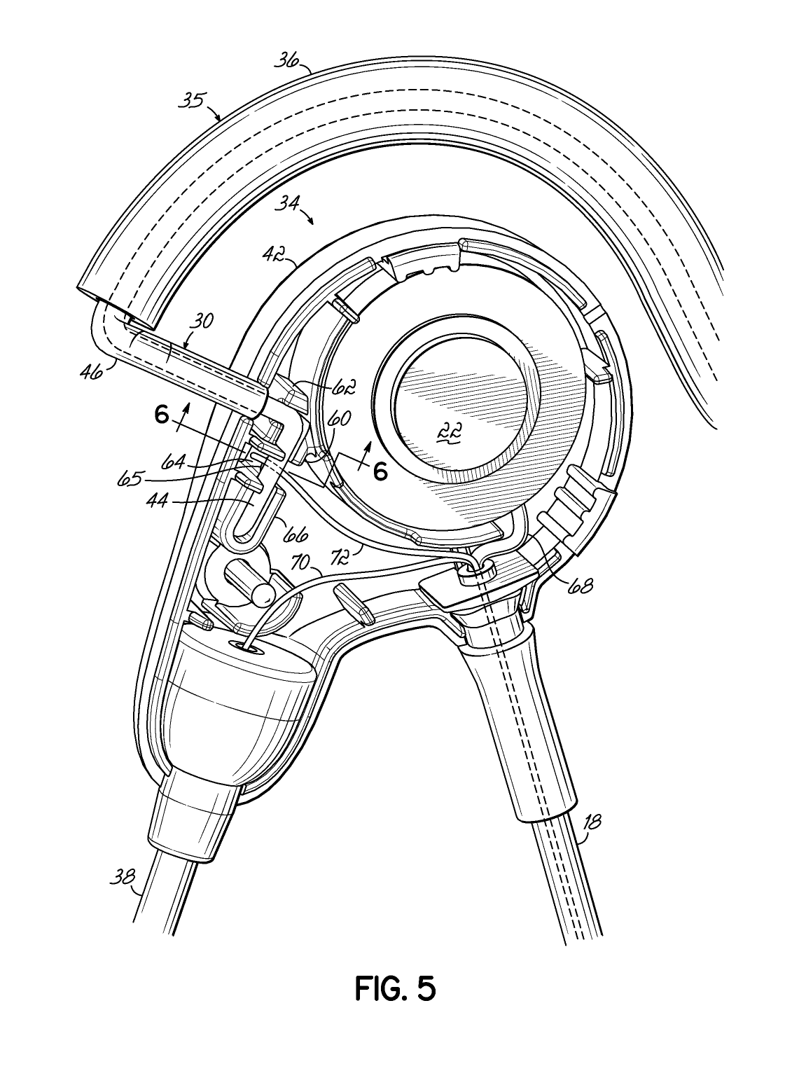

FIG. 5 is an illustration of at least some of the electrical connections and components in the earpiece assembly 34, and in particular is an illustration of the earpiece assembly 34 with the outer housing 43 removed. The support band 30 engages and is secured to the earpiece assembly 34. Inside the earpiece assembly 34, at least a portion of the support member 44 is bare metal and is exposed (e.g., it is not sheathed by the support member sheath 46 inside the earpiece assembly 34). The support member 44 is held in place by a series of retention ribs 60-66, which may be integral to the lower housing 42 of the earpiece assembly 34. The retention ribs 60-66 include ribs 60, 62, and 64 that contact the bare support member 44 when it enters the housing, and when it is bent at an angle of about 90°. Support rib 64 captures the support member 44 from its sides and below. Retention rib 66 is substantially U-shaped and receives and secures the end of the support member 44. The ribs 60-66 are designed to prevent lateral movement or removal, of the support member 44 with respect to the earpiece assembly 34 when the earpiece assembly 34 is assembled. The earpiece assembly rotates slightly around the member 44 for adjustment and comfort.

As illustrated in FIG. 5, the cord 18 from the device 10 is received by the earpiece assembly 34 and contains a plurality of conductors to connect to the components of the headset 12. Specifically, a speaker line 68 is connected to the speaker 22, a microphone line 70 is connected to the microphone 24, and a ground line or conductor 72 is electrically coupled with the support member 44. The ground conductor 72 is manufactured from a suitable metal, and may be a bare copper conductor line. The ground conductor is electrically connected to a ground reference provided by the device 10, as illustrated in FIG. 1. Therefore, earpiece assembly 34 has a ground conductor that is electrically coupled between the conductive band and the device.

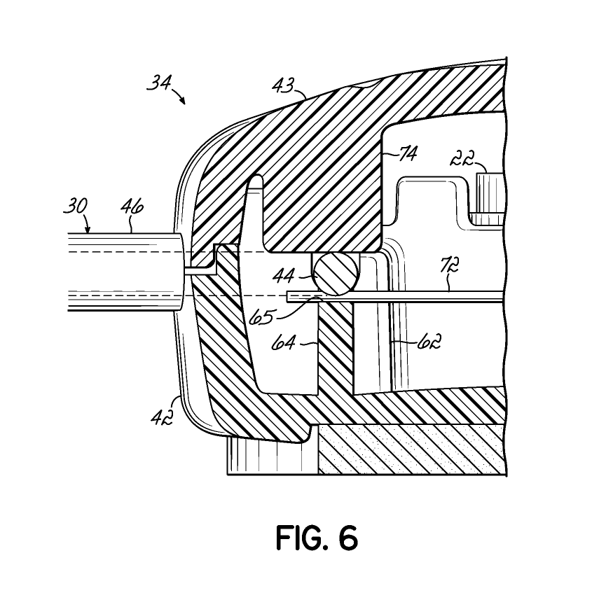

In accordance with one aspect of the invention, the ground conductor 72 is electrically coupled to the metal of support member 44 to ground the member 44 and also to provide a ground path to pad 40 and the skin in the temple area of a user's head. The ground conductor 72 is positioned between the support member 44 and the rib 64 such that, when the earpiece assembly 34 is assembled, the support member 44 is captured and forced against conductor 72 to thereby be electrically coupled with the ground conductor 72. Specifically, FIG. 6 illustrates that a projection 74 from the outer housing 43 is configured to push down against the end of member 44 proximate the retention rib 64 to hold the support member 44 against the ground conductor 72 and the support rib 64 when the earpiece assembly 34 is assembled. The ground conductor is thus “smashed” against the member 44. The ground conductor 72 is thus operable to maintain the headset 12 and device 10 at the same ground potential. The rib 64, as illustrated in FIGS. 5 and 6, may include a notch 65 formed therein to receive ground line 72 in the proper position to be appropriately pressed against and into electrical contact with the support member when the headset is assembled.

Embodiments of the invention address drawbacks in the prior art by establishing electrical ground connection between a device 10 and a headset 12 to maintain the headset 12 and the device 10 at the same ground potential. The headset 12 includes components that establish electrical coupling between the head of user 14 and the headset 12, and thus the device 10, through a universally movable or rotatable temple headpiece 32. Embodiments of the invention particularly provide a ground path to the user 14 that is seamlessly incorporated into the mechanical components of the headset 12. The potential for an electrostatic discharge between a user 14 and the headset 12 and/or device 10 may thus be reduced or eliminated. Static sensitive components of the headset 12, specifically the speaker 22 and/or microphone 24 of the headset 12, are also protected, as the likelihood of electrostatic discharge into those components is reduced, if not eliminated, and/or shifted to insignificant components, such as the outer casing of the device 10. The present invention provides a static discharge path using the same components as mounted on a headset. Good contact and electrical conductivity and grounding is maintained, even through articulating components. The user will be generally unaware that the feature provides the benefit noted and does not have to wear or engage a separate grounding apparatus.

Moreover, embodiments of the invention provide for improved construction of the headset 12. Conventional methods of insulating a headset 12 require insulating individual components. Embodiments of the invention may not require such insulation, potentially decreasing the size of the headset 12 as well as decreasing the weight of the headset 12.

Those having ordinary skill in the art will recognize that the environments illustrated in FIGS. 1-3, 4A-4B, and 5-6 are not intended to limit the scope of embodiments of the invention. In particular, the device 10 and/or headset 12 may include additional components consistent with alternative embodiments of the invention. Indeed, those having skill in the art will recognize that other alternative hardware environments may be used without departing from the scope of the invention. For example, the headset 12 may be further configured with a processing unit and memory. As such, the headset 12 may control at least some communications with the device 10 and/or provide control of at least some functions normally performed by the device 10. Moreover, although the support band 30 is illustrated as being configured to fit around the back of the head of the user 14, the support band 30 may be configured to fit around the top of the head of the user 14, configured to fit around the neck of the user 14, or configured in some alternative manner to fit about the head and/or neck of the user 14.

The temple headpiece 32 may also be configured to be in a different location than that shown and described. For example, the temple headpiece 32 may be configured to be located above an ear of the user 14, below the ear of the user 14, on the ear of the user 14, on the neck of the user 14, on the cheekbone of the user 14, or on some alternative location of the head of the user 14. The location for the electrically conductive foam pad 40 and/or its electrical connection to the support member 44 may also be configured in a different location than that shown and described. For example, the foam pad 40 may be configured in the middle of the support band 30 such that the foam pad 40 is in electrical communication with the back of the head or the neck of the user 14. Alternatively, the foam pad 40 may be configured at the earpiece assembly 34 and in electrical communication with an ear of the user 14.

Thus, while embodiments of the invention have been illustrated by a description of the various embodiments and the examples, and while these embodiments have been described in considerable detail, it is not the intention of the applicants to restrict or in any way limit the scope of the appended claims to such detail. Additional advantages and modifications will readily appear to those skilled in the art. Thus, embodiments of the invention in broader aspects are therefore not limited to the specific details and representative apparatuses. Accordingly, departures may be made from such details without departing from the scope of applicant's general inventive concept.

Other modifications will be apparent to one of ordinary skill in the art. Therefore, the invention lies in the claims hereinafter appended.

What is claimed is:

1. A headset for a portable device, comprising:
an electrically conductive band configured to engage a portion of a head of a user;
a headpiece that includes an electrically conductive portion that is configured to engage and electrically couple to the user's head, the headpiece being electrically coupled with the conductive band;
an earpiece assembly coupled with the conductive band to engage an ear of a user, the earpiece assembly having a ground conductor that is electrically coupled between the conductive band and a portable device for electrically coupling the portable device to the head of a user for reducing electrostatic discharge at the head of the user of the portable device.

2. The headset of claim 1, further comprising:
a non-conductive sheath that covers at least a portion of the band.

3. The headset of claim 1, wherein the headpiece includes:
an electrically conductive pad configured to lie against a portion of the user's head, the conductive pad electrically coupled with the conductive band.

4. The headset of claim 3, wherein the headpiece includes:
a universal joint coupled with the conductive band to provide universal movement of the headpiece with respect to the conductive band, the universal joint providing an electrical coupling with the conductive band.

5. The headset of claim 4, wherein the headpiece further includes:
a conductive ball coupled to the conductive band;
a conductive plate electrically coupled with the conductive pad;
the ball moving on the plate to provide the universal movement and electrical coupling with the conductive band

6. The headset of claim 5, wherein the conductive plate is attached to at least a portion of the conductive pad with an electrically conductive adhesive.

7. The headset of claim 5, wherein the headpiece includes a housing the conductive ball movable against a portion of the housing to provide the universal movement.

8. The headset of claim 3, wherein the headpiece further comprises;
a conductive plate electrically coupled with the conductive pad;
portions of the plate forming projections that extend from the plate, the electrically conductive band engaging the projections.

9. The headset of claim 8, wherein the conductive plate is attached to at least a portion of the conductive pad with an electrically conductive adhesive.

10. The headset of claim 8, wherein the plate is rotatable about a lengthwise axis of the conductive band that engages the projections.

11. The headset of claim 1, wherein the headpiece is located on an opposite end of the band from the earpiece assembly.

12. The headset of claim 1 wherein the earpiece assembly includes a speaker.

13. The headset of claim 1, further comprising a microphone.

14. The headset of claim 1, wherein the conductive band surrounds at least a portion of a head of a user.

15. A system comprising:
a portable device including a source of a ground potential;
a headset having a cable configured for coupling with the portable device, the cable including at least one ground conductor that is coupled to the ground source of the device, the headset further comprising:
an electrically conductive band configured to engage a portion of a head of a user;
a headpiece that includes an electrically conductive portion that is configured to engage and electrically couple to the user's head, the headpiece being electrically coupled with the conductive band;
an earpiece assembly coupled with the conductive band to engage an ear of a user, the conductive band being electrically coupled with the cable ground conductor at the earpiece for coupling the portable device to the head of a user for reducing electrostatic discharge at the head of the user of the portable device.

16. The system of claim 15, wherein the headset headpiece includes an electrically conductive pad configured to lie against a portion of the user's head, the conductive pad electrically coupled with the conductive band.

17. The system of claim 15, wherein the headpiece includes:
a universal joint coupled with the conductive band to provide universal movement of the headpiece with respect to the conductive band, the universal joint providing an electrical coupling with the conductive band.

18. The system of claim 17, wherein the headpiece further includes:
a conductive ball coupled to the conductive band;
a conductive plate electrically coupled with the conductive pad;
the ball moving on the plate to provide the universal movement and electrical coupling with the conductive band

19. The system of claim 18, wherein the headpiece includes a housing, the conductive ball movable against a portion of the housing to provide the universal movement.

20. The system of claim 15, wherein the headpiece further comprises;
a conductive plate electrically coupled with the conductive pad;
portions of the plate forming projections that extend from the plate, the electrically conductive band engaging the projections.

21. The system of claim 20, wherein the plate is rotatable about a lengthwise axis of the conductive band that engages the projections.
